(19) United States
(12) Patent Application Publication
(10) Pub. No.: US 2026/0229490 A1
(43) Pub. Date: Aug. 6, 2026

(54) POSITIVE ELECTRODE MATERIAL, ELECTROCHEMICAL DEVICE AND ELECTRONIC DEVICE

(71) Applicant: NINGDE AMPEREX TECHNOLOGY LIMITED, Ningde (CN)

(72) Inventors: Shiyang CHENG, Ningde (CN); Hui ZHANG, Ningde (CN); Ye LANG, Ningde (CN); Leimin XU, Ningde (CN)

(73) Assignee: NINGDE AMPEREX TECHNOLOGY LIMITED, Ningde (CN)

(21) Appl. No.: 19/635,146

(22) Filed: Mar. 31, 2026

Related U.S. Application Data
(63) Continuation of application No. PCT/CN2023/125759, filed on Oct. 20, 2023.

(51) Int. Cl. H01M 4/36; H01M 4/02; H01M 4/131; H01M 4/525; H01M 10/0525

(52) U.S. Cl. CPC H01M 4/362; H01M 4/131; H01M 4/525; H01M 10/0525; H01M 2004/028

(57) ABSTRACT

A positive electrode material, where when an electrode including the positive electrode material is assembled with a lithium sheet into a coin cell, and the coin cell is charged to 4.4V at a constant current of 0.1C within a range of 2.8V to 4.4V, based on a weight of the positive electrode material, a specific charge capacity of the positive electrode material is greater than or equal to 220 mAh/g, and a cell volume change rate ΔV1 of the positive electrode material is 7% to 11%. The positive electrode material, while having a high specific charge capacity, exhibits excellent structural stability, thereby improving float charge performance and high-temperature storage performance of the electrochemical device.

### CROSS-REFERENCE TO RELATED APPLICATIONS

This application is a continuation application of PCT International Application No. PCT/CN2023/125759, filed on Oct. 20, 2023, the content of which is incorporated herein by reference in its entirety.

### TECHNICAL FIELD

This application relates to the field of energy storage, specifically, to a positive electrode material, an electrochemical device, and an electronic device.

### BACKGROUND

With the widespread use of consumer electronic products such as laptops, mobile phones, tablets, portable power supplies, and drones, the requirements for their batteries are increasingly stringent. For instance, batteries are required not only to be lightweight but also to possess high capacity and long service life. Lithium-ion batteries have become dominant in the market due to their outstanding advantages, including high energy density, good safety, no memory effect, and long service life.

To pursue higher energy density, lithium-ion batteries have been developed toward higher voltage and higher lithium deintercalation. Under high voltage and high lithium deintercalation, issues such as oxygen release from the surface of positive electrode materials and structural phase transitions become prominent, leading to problems such as rapid capacity decay during cycling and gas generation of the battery. Additionally, the poor kinetics of ternary materials limit their capacity performance and cause significant battery temperature rise, posing safety concerns.

### SUMMARY

In view of this, according to a first aspect, this application provides a positive electrode material, where when an electrode including the positive electrode material is assembled with a lithium sheet into a coin cell, and the coin cell is charged to 4.4V at a constant current of 0.1C within a range of 2.8V to 4.4V, based on a weight of the positive electrode material, the positive electrode material has a specific charge capacity greater than or equal to 220 mAh/g, and a cell volume change rate ΔV1 of the positive electrode material is 7% to 11%.

Typically, a capacity of a positive electrode ternary material is primarily generated through valence changes of nickel and cobalt elements. The capacity of the positive electrode material is related to a nickel content in the positive electrode material, with a higher nickel content resulting in a higher capacity of the positive electrode material. Meanwhile, Mn in the positive electrode material, in the +4 valence state, does not contribute to capacity and further limits an energy density of the material, and a low electrochemical activity of manganese leads to poor material kinetics. Under deep lithium deintercalation, the high activity of oxygen ions on the material surface easily triggers side reactions with an electrolyte, increasing interfacial impedance or causing gas generation. Additionally, a low lithium-oxygen interlayer spacing in the ternary material hinders lithium-ion diffusion at the end of discharge, leading to kinetic lag of the material and increased battery temperature rise.

The inventors of this application have found that doping element in the lithium layer through synthesis method can regulate internal oxygen defects and lithium-oxygen interlayer spacing of the material. Introducing oxygen defects within the material can activate a redox property of a transition metal, significantly improving an energy density of the material. Further, oxygen vacancies formed on the surface can reduce the activity of oxygen on the material surface, stabilizing outer-layer oxygen ions of the material and suppressing oxygen release and gas generation during float charge and high-temperature storage of the positive electrode material. In addition, doping a high-ionic-radius element in the lithium layer increases the lithium-oxygen interlayer spacing, increasing the cell parameter change rate during lithium-ion intercalation/deintercalation, which promotes full lithium-ion intercalation/deintercalation and improves kinetic performance of the material.

Therefore, a positive electrode material having a cell volume change rate ΔV1 as described in this application and a specific capacity greater than or equal to 220 mAh/g as described in this application can provide higher energy density and improved kinetic performance for an electrochemical device.

According to some embodiments of this application, when an electrode including the positive electrode material is assembled with a lithium sheet into a coin cell, and the coin cell is charged to 4.0V at a constant current of 0.1C within a range of 2.8V to 4.4V, a cell volume change rate ΔV2 of the positive electrode material is less than or equal to 3.5%. Thus, the positive electrode material of this application exhibits a relatively small cell volume change rate in the low-voltage range, enabling superior structural stability of the positive electrode material, and improving the float charge performance and high-temperature storage performance of the electrochemical device.

According to some embodiments of this application, a cell parameter a of the positive electrode material satisfies: 2.8 Å≤a≤3.0 Å.

According to some embodiments of this application, a cell parameter c of the positive electrode material satisfies: 14.3 Å≤c≤14.8 Å. Thus, the positive electrode material of this application has an increased lithium-oxygen interlayer spacing, which promotes full lithium-ion intercalation/deintercalation and enhances kinetic performance of the material.

According to some embodiments of this application, a cell volume V of the positive electrode material satisfies: 103 Å³≤V≤115 Å³.

According to some embodiments of this application, when the coin cell is charged to 4.4V at the constant current of 0.1C within the range of 2.8V to 4.4V, an oxygen release onset temperature of the positive electrode material is greater than or equal to 220° C. The oxygen vacancies formed within and on the surface of the positive electrode material of this application reduce the activity of oxygen in the material, and element doping in the lithium layer suppresses structural collapse of the material under high lithium deintercalation, thereby inhibiting oxygen release from the positive electrode material and enhancing structural stability of the positive electrode material under high temperature and high voltage.

According to some embodiments of this application, when an electrode including the positive electrode material is assembled with a lithium sheet into a coin cell, and the coin cell is charged and discharged at a current of 0.1C within a range of 2.8V to 4.4V, an obtained differential capacity to voltage dQ/dV curve exhibits a first oxidation peak and a first reduction peak within a range of 4.2V to 4.4V.

According to some embodiments of this application, the obtained differential capacity to voltage dQ/dV curve exhibits a second oxidation peak and a second reduction peak within a range of 3.5V to 4.0V.

According to some embodiments of this application, the positive electrode material includes a lithium transition metal composite oxide; and the lithium transition metal composite oxide includes element T and optionally element M, where element T includes at least one of Ni, Co, or Mn, and element M includes at least one of K, Ca, Sr, Y, Zr, Nb, Mo, In, Sn, Sb, Ba, La, Ce, Hf, Ta, W, Pb, Al, Mg, B, Si, P, S, Ti, V, Cr, Fe, Cu, Zn, Ga, or Ge.

According to some embodiments of this application, based on a total molar amount of element T, a molar percentage of Ni is 30% to 70%. According to some embodiments of this application, based on a total molar amount of element T, a molar percentage of Mn is 0% to 70%. According to some embodiments of this application, based on a total molar amount of element T, a molar percentage of Co is 0% to 50%.

According to some embodiments of this application, based on a total molar amount of elements T and M, a molar percentage of element T is 90% to 100%, and a molar percentage of element M is 0% to 10%.

According to some embodiments of this application, the lithium transition metal composite oxide further includes element R, where element R includes at least one of F, Cl, Br, I, or N, and based on a total molar amount of elements T and M, a molar percentage of element R is 0.1% to 10%.

According to some embodiments of this application, in the lithium transition metal composite oxide, a ratio of a molar amount of element Li to a total molar amount of elements T and M is 0.5 to 1.1.

According to some embodiments of this application, the lithium transition metal composite oxide further includes element Na, and based on the total molar amount of elements T and M, a molar percentage of element Na is 0.1% to 20%.

According to some embodiments of this application, the lithium transition metal composite oxide has a layered crystal structure.

According to some embodiments of this application, the lithium transition metal composite oxide includes Liₓ₁Naₓ₂Ni_{y1}Mn_{y2}CO_{y3}M_{z1}O_{2±m}Rₘ, where 0.5≤x1≤1.1, 0.001≤x2≤0.2, 0.3≤y1≤0.7, 0≤y2≤0.7, 0≤y3≤0.5, 0≤z1≤0.1, and 0≤m≤0.1, and element R includes at least one of F, Cl, Br, I, or N.

According to a second aspect, this application provides an electrochemical device, where the electrochemical device includes a positive electrode plate, and the positive electrode plate includes the positive electrode material according to the first aspect of this application.

According to some embodiments of this application, the electrochemical device further includes an electrolyte, where the electrolyte includes an additive, and the additive includes at least one of a sulfur-oxygen double bond containing compound or a multi-cyano containing compound. The sulfur-oxygen double bond containing compound may form an oxidation-resistant protective film on a surface of the positive electrode material, and the abundant element S may stabilize a high-valence transition metal in the charged state, thereby better suppressing oxygen release from a surface of the positive electrode material and oxidative decomposition of the electrolyte. The multi-cyano containing compound can complex with a transition metal on the surface of the positive electrode active material, stabilizing transition metals such as nickel, cobalt, and manganese on the surface of the positive electrode material, suppressing oxygen release from the surface of the positive electrode material, thereby improving the structural stability of the positive electrode material under high temperature and high voltage.

According to some embodiments of this application, the sulfur-oxygen double bond containing compound includes at least one of 1,3-propane sultone, ethylene sulfate, 2,4-butane sultone, 1,4-butane sultone, methylene methanedisulfonate, 1,3-propane disulfonic anhydride, 4-methyl vinyl sulfate, or pentaerythritol bicyclic sulfate.

According to some embodiments of this application, based on a mass of the electrolyte, a mass percentage of the sulfur-oxygen double bond containing compound is 0.1% to 5%.

According to some embodiments of this application, the multi-cyano containing compound includes at least one of succinonitrile, glutaronitrile, adiponitrile, pimelonitrile, suberonitrile, azelanitrile, sebaconitrile, methyl glutaronitrile, 1,2-bis(2-cyanoethoxy)ethane, 1,3,5-pentanetricarbonitrile, 1,3,6-hexanetricarbonitrile, or 1,2,3-tris(2-cyanoethoxy)propane.

According to some embodiments of this application, based on a mass of the electrolyte, a mass percentage of the multi-cyano containing compound is 0.5% to 10%.

According to a third aspect, this application provides an electronic device, including the electrochemical device according to the second aspect of this application.

### BRIEF DESCRIPTION OF DRAWINGS

FIG. 1 shows a relationship between cell volume and specific capacity for Example 7, Comparative example 1, and Comparative example 2.

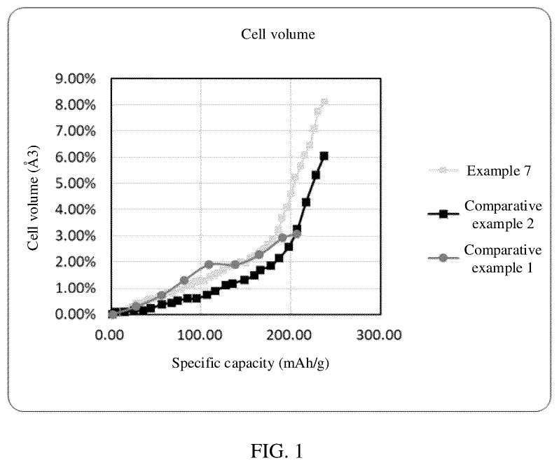

### DETAILED DESCRIPTION

To make the objectives, technical solutions, and advantages of this application clearer, the technical solutions of this application will be described clearly and thoroughly below with reference to embodiments. It is clear that the described embodiments are only some but not all embodiments of this application. These embodiments described herein are illustrative in nature and are intended to provide a basic understanding of this application. These embodiments of this application should not be construed as limitations on this application.

For brevity, only certain numerical ranges are explicitly disclosed herein. However, any lower limit may be combined with any upper limit to form a range not explicitly stated; any lower limit may be combined with any other lower limit to form a range not explicitly stated, and any upper limit may be combined with any other upper limit to form a range not explicitly stated. Additionally, each individually disclosed point or single numerical value may serve as a lower or upper limit to combine with any other point or single numerical value or with any other lower or upper limit to form a range not explicitly stated.

In the description herein, unless otherwise specified, “above” and “below” include the number itself.

Unless otherwise specified, terms used in this application have the commonly understood meanings known by a person skilled in the art. Unless otherwise specified, the numerical values of parameters mentioned in this application can be measured using various measurement methods commonly used in the art (for example, they can be tested according to the methods provided in some embodiments of this application).

The terms “at least one of”, “at least one”, or “at least one type of” or other similar terms referring to a list of items may imply any combination of the listed items. For example, if items A and B are listed, the phrase “at least one of A or B” means only A; only B; or A and B. In another instance, if items A, B, and C are listed, the phrase “at least one of A, B, or C” means only A; only B; only C; A and B (excluding C); A and C (excluding B); B and C (excluding A); or all of A, B, and C. Item A may include a single component or multiple components. Item B may include a single component or multiple components. Item C may include a single component or multiple components.

### 1. Positive Electrode Material

According to a first aspect, this application provides a positive electrode material. When an electrode including the positive electrode material is assembled with a lithium sheet into a coin cell, and the coin cell is charged to 4.4V at a constant current of 0.1C within a voltage range of 2.8V to 4.4V, based on a weight of the positive electrode material, the positive electrode material has a specific charge capacity greater than or equal to 220 mAh/g, for example, 220 mAh/g, 230 mAh/g, 240 mAh/g, 250 mAh/g, 260 mAh/g, 270 mAh/g, 280 mAh/g, 290 mAh/g, 300 mAh/g, 310 mAh/g, 320 mAh/g, 330 mAh/g, or any range defined by them, and a cell volume change rate ΔV1 of the positive electrode material is 7% to 11%, for example, ΔV1 is 7.0%, 7.2%, 7.4%, 7.6%, 7.8%, 8.0%, 8.2%, 8.4%, 8.6%, 8.8%, 9.0%, 9.2%, 9.4%, 9.6%, 9.8%, 10.0%, 10.2%, 10.4%, 10.6%, 10.8%, 11.0%, or any range defined by them.

In this application, the cell volume change rate ΔV1 is obtained through the following test method: For a synthesized initial positive electrode material, an X-ray powder diffractometer (XRD, model: Bruker D8 ADVANCE; target: Cu Kα; voltage/current: 40 kV/40 mA; and scanning angle range: 10° to 70°) is used for test; the XRD results are fitted using the Rietveld method to obtain cell parameters a, c, and cell volume V. The synthesized initial positive electrode material is assembled with a lithium sheet into a coin cell, and the coin cell is charged to a specified voltage (such as 4.0V or 4.4V) at a constant current of 0.1C within a range of 2.8V to 4.4V. A resulting positive electrode plate is obtained by disassembly, soaked and washed with dimethyl carbonate (DMC), dried, and subjected to the above XRD test. The XRD results are fitted using the Rietveld method to obtain cell volume V′ based on fitting results. In this case, the cell volume change rate ΔV is (V′−V)/V×100%. For the positive electrode material in a full cell, the only difference is that the full cell is fully discharged and then disassembled to obtain a positive electrode plate, which is soaked and washed with dimethyl carbonate (DMC), dried, and subjected to the above XRD test to obtain cell parameters a, c, and cell volume V.

The inventors of this application have found that doping element in the lithium layer through synthesis method can regulate internal oxygen defects and lithium-oxygen interlayer spacing of the material. Introducing oxygen defects within the material can activate a redox property of a transition metal, significantly improving an energy density of the material. Further, oxygen vacancies formed on the surface can reduce the activity of oxygen on the material surface, stabilizing outer-layer oxygen ions of the material and suppressing oxygen release and gas generation during float charge and high-temperature storage of the positive electrode material. In addition, doping a high-ionic-radius element in the lithium layer increases the lithium-oxygen interlayer spacing, increasing the cell parameter change rate during lithium-ion intercalation/deintercalation, which promotes full lithium-ion intercalation/deintercalation and improves kinetic performance of the material.

In some embodiments, when an electrode including the positive electrode material is assembled with a lithium sheet into a coin cell, and the coin cell is charged to 4.0V at a constant current of 0.1C within a range of 2.8V to 4.4V, the cell volume change rate ΔV2 of the positive electrode material is less than or equal to 3.5%, for example, ΔV2 is 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, or any range defined by them. Thus, the positive electrode material of this application exhibits a relatively small cell volume change rate in the low-voltage range, enabling superior structural stability of the positive electrode material, and improving the float charge performance and high-temperature storage performance of the electrochemical device.

In some embodiments, the cell parameter a of the positive electrode material satisfies: 2.8 Å≤a≤3.0 Å, for example, a is 2.8 Å, 2.82 Å, 2.84 Å, 2.86 Å, 2.90 Å, 2.92 Å, 2.94 Å, 2.96 Å, 2.98 Å, 3.0 Å, or any range defined by them. According to some embodiments of this application, the cell parameter c of the positive electrode material satisfies: 14.3 Å≤c≤14.8 Å, for example, c is 14.3 Å, 14.4 Å, 14.5 Å, 14.6 Å, 14.7 Å, 14.8 Å, or any range defined by them. According to some embodiments of this application, the cell volume V of the positive electrode material satisfies: 103 Å³≤V≤115 Å³, for example, V may be 103 Å³, 104 Å³, 105 Å³, 106 Å³, 107 Å³, 108 Å³, 109 Å³, 110 Å³, 111 Å³, 112 Å³, 113 Å³, 114 Å³, 115 Å³, or any range defined by them.

In some embodiments, when the coin cell is charged to 4.4V at a constant current of 0.1C within a range of 2.8V to 4.4V, an oxygen release onset temperature of the positive electrode material is greater than or equal to 220° C., for example, 220° C., 230° C., 240° C., 250° C., 260° C., 270° C., 280° C., 290° C., 300° C., 310° C., 320° C., 330° C., 340° C., 350° C., or any range defined by them. The oxygen vacancies formed within and on the surface of the positive electrode material of this application reduce the activity of oxygen in the material, and element doping in the lithium layer suppresses structural collapse of the material under high lithium deintercalation, thereby inhibiting oxygen release from the positive electrode material and enhancing structural stability of the positive electrode material under high temperature and high voltage.

In some embodiments, when an electrode including the positive electrode material is assembled with a lithium sheet into a coin cell, and the coin cell is charged and discharged at a current of 0.1C within a range of 2.8V to 4.4V, an obtained differential capacity to voltage dQ/dV curve exhibits a first oxidation peak and a first reduction peak in the range of 4.2V to 4.4V.

In some embodiments, the obtained differential capacity to voltage dQ/dV curve exhibits a second oxidation peak and a second reduction peak in the range of 3.5V to 4.0V.

In some embodiments, the positive electrode material includes a lithium transition metal composite oxide; the lithium transition metal composite oxide includes element T and optionally element M, where element T includes at least one of Ni, Co, or Mn, and element M includes at least one of K, Ca, Sr, Y, Zr, Nb, Mo, In, Sn, Sb, Ba, La, Ce, Hf, Ta, W, Pb, Al, Mg, B, Si, P, S, Ti, V, Cr, Fe, Cu, Zn, Ga, or Ge.

In some embodiments, based on a total molar amount of element T, a molar percentage of Ni is 30% to 70%, for example, 30%, 35%, 40%, 45%, 50%, 55%, 60%, 65%, 70%, or any range defined by them. According to some embodiments of this application, based on a total molar amount of element T, the molar percentage of Mn is 0% to 70%, for example, 0%, 5%, 10%, 15%, 20%, 25%, 30%, 35%, 40%, 45%, 50%, 55%, 60%, 65%, 70%, or any range defined by them. According to some embodiments of this application, based on the total molar amount of element T, the molar percentage of Co is 0% to 50%, for example, 0%, 5%, 10%, 15%, 20%, 25%, 30%, 35%, 40%, 45%, 50%, or any range defined by them.

In some embodiments, based on a total molar amount of elements T and M, a molar percentage of element T is 90% to 100%, for example, 90%, 91%, 94%, 96%, 98%, 99%, 100%, or any range defined by them, and the molar percentage of element M is 0% to 10%, for example, 0%, 0.1%, 0.5%, 1%, 2%, 3%, 4%, 5%, 6%, 7%, 8%, 9%, 10%, or any range defined by them.

In some embodiments, the lithium transition metal composite oxide further includes element R, where element R includes at least one of F, Cl, Br, I, or N, and based on the total molar amount of elements T and M, the molar percentage of element R is 0.1% to 10%, for example, 0.1%, 0.5%, 1%, 2%, 3%, 4%, 5%, 6%, 7%, 8%, 9%, 10%, or any range defined by them.

In some embodiments, in the lithium transition metal composite oxide, a ratio of the molar amount of element Li to the total molar amount of elements T and M is 0.5 to 1.1, for example, 0.5, 0.6, 0.7, 0.8, 0.9, 1.0, 1.1, or any range defined by them.

In some embodiments, the lithium transition metal composite oxide further includes element Na, and based on the total molar amount of elements T and M, the molar percentage of element Na is 0.1% to 20%, for example, 0.1%, 0.5%, 1%, 2%, 3%, 4%, 5%, 6%, 7%, 8%, 9%, 10%, 11%, 12%, 13%, 14%, 15%, 16%, 17%, 18%, 19%, 20%, or any range defined by them.

In some embodiments, the lithium transition metal composite oxide has a layered crystal structure.

In some embodiments, the lithium transition metal composite oxide includes Liₓ₁Naₓ₂Ni_{y1}Mn_{y2}Co_{y3}M_{z1}O_{2±m}Rₘ, where 0.5≤x1≤1.1, 0.001≤x2≤0.2, 0.3≤y1≤0.7, 0≤y230.7, 0≤y3≤0.5, 0≤z1≤0.1, and 0≤m≤0.1, and element R includes at least one of F, Cl, Br, I, or N.

### 2. Electrochemical Device

The electrochemical device provided in this application includes a positive electrode, and the positive electrode includes a positive electrode material according to the first aspect of this application.

According to some embodiments of this application, the positive electrode further includes a conductive agent and a binder. In some embodiments, the binder includes, but is not limited to, polyvinyl alcohol, hydroxypropyl cellulose, diacetyl cellulose, polyvinyl chloride, carboxylated polyvinyl chloride, polyvinyl fluoride, polytetrafluoroethylene, polyvinylidene fluoride, or vinylidene fluoride-hexafluoropropylene copolymer. In some embodiments, the conductive agent includes, but is not limited to, a carbon-based material, metal-based material, conductive polymer, or mixture thereof. In some embodiments, the carbon-based material is selected from carbon black, acetylene black, Ketjen black, carbon fiber, carbon nanotubes, graphene, or any combination thereof. In some embodiments, the metal-based material is selected from metal powder or metal fiber. In some embodiments, the conductive polymer is a polyphenylene derivative.

According to some embodiments of this application, the positive electrode further includes a positive electrode current collector. In some embodiments, the positive electrode current collector may be a metal foil or a composite current collector. For example, aluminum foil may be used. The composite current collector may be formed by forming a metal material on a polymer substrate.

According to some embodiments of this application, the electrochemical device further includes a negative electrode.

According to some embodiments of this application, the negative electrode includes a negative electrode current collector and a negative electrode active material layer disposed on a surface of the negative electrode current collector. In some embodiments, the negative electrode active material layer includes a negative electrode active material. In some embodiments, the negative electrode active material includes at least one of a carbon material or a silicon material. The carbon material includes at least one of graphite or hard carbon, and the silicon material includes at least one of silicon, silicon-oxygen compound, silicon-carbon compound, or silicon alloy. In some embodiments, the negative electrode active material layer includes a binder. In some embodiments, the binder includes at least one of polyamide, polyacrylonitrile, acrylate polymer, polyacrylic acid, polyacrylate, sodium carboxymethyl cellulose, polyvinylpyrrolidone, or styrene-butadiene rubber. In some embodiments, the negative electrode active material layer further includes a conductive material to improve electrode conductivity. In some embodiments, the conductive material includes at least one of conductive carbon black, acetylene black, carbon nanotubes, Ketjen black, or graphene.

According to some embodiments of this application, the electrochemical device further includes an electrolyte or a solid electrolyte.

According to some embodiments of this application, the electrolyte used in some embodiments of this application may be an electrolyte known in the prior art.

In some embodiments, the electrolyte includes an organic solvent, a lithium salt, and an additive. In some embodiments, the organic solvent includes, but is not limited to, ethylene carbonate (EC), propylene carbonate (PC), diethyl carbonate (DEC), ethyl methyl carbonate (EMC), dimethyl carbonate (DMC), propylene carbonate, or ethyl propionate. In some embodiments, the lithium salt includes at least one of an organic lithium salt or an inorganic lithium salt. In some embodiments, the lithium salt includes, but is not limited to, lithium hexafluorophosphate (LiPF₆), lithium tetrafluoroborate (LiBF₄), lithium difluorophosphate (LiPO₂F₂), lithium bis(trifluoromethanesulfonyl)imide LiN(CF₃SO₂)₂ (LiTFSI), lithium bis(fluorosulfonyl)imide LiN(SO₂F)₂ (LiFSI), lithium bis(oxalato) borate LiB(C₂O₄)₂, (LiBOB), or lithium difluoro(oxalato)borate LiBF₂(C₂O₄) (LiDFOB). In some embodiments, the additive includes at least one of a sulfur-oxygen double bond containing compound or a multi-cyano containing compound.

In some embodiments, the sulfur-oxygen double bond containing compound includes at least one of 1,3-propane sultone, ethylene sulfate, 2,4-butane sultone, 1,4-butane sultone, methylene methanedisulfonate, 1,3-propane disulfonic anhydride, 4-methyl vinyl sulfate, or pentaerythritol bicyclic sulfate. In some embodiments, based on a mass of the electrolyte, a mass percentage of the sulfur-oxygen double bond containing compound is 0.1% to 5%, for example, 0.1%, 0.5%, 1.0%, 1.5%, 2.0%, 2.5%, 3.0%, 3.5%, 4.0%, 4.5%, 5.0%, or any range defined by them. In some embodiments, the multi-cyano containing compound includes at least one of succinonitrile, glutaronitrile, adiponitrile, pimelonitrile, suberonitrile, azelanitrile, sebaconitrile, methyl glutaronitrile, 1,2-bis(2-cyanoethoxy)ethane, 1,3,5-pentanetricarbonitrile, 1,3,6-hexanetricarbonitrile, or 1,2,3-tris(2-cyanoethoxy)propane. In some embodiments, based on a mass of the electrolyte, a mass percentage of the multi-cyano containing compound is 0.5% to 10%, for example, 0.5%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, or any range defined by them.

According to some embodiments of this application, the electrochemical device is provided with a separator between the positive electrode and the negative electrode to prevent short circuits. A material and shape of the separator used in these embodiments of this application are not particularly limited and may be any technology disclosed in the prior art. In some embodiments, the separator includes a polymer or inorganic material formed from a material stable to the electrolyte of this application. For example, the separator may include a substrate and a surface treatment layer. The substrate is a nonwoven fabric, film, or composite film with a porous structure, and the material of the substrate includes at least one of polyethylene, polypropylene, polyethylene terephthalate, or polyimide. Specifically, a polypropylene porous film, polyethylene porous film, polypropylene nonwoven fabric, polyethylene nonwoven fabric, or polypropylene-polyethylene-polypropylene porous composite film may be used. A surface treatment layer is provided on at least one surface of the substrate layer, and the surface treatment layer may be a polymer layer or an inorganic layer, or a layer formed by mixing a polymer and an inorganic material. The inorganic layer includes inorganic particles and a binder, where the inorganic particles include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder includes at least one of polyvinylidene fluoride, vinylidene fluoride-hexafluoropropylene copolymer, polyamide, polyacrylonitrile, acrylate polymer, polyacrylic acid, polyacrylate, polyvinylpyrrolidone, polyvinyl ether, polytetrafluoroethylene, or polyhexafluoropropylene. The polymer layer includes a polymer, and a material of the polymer includes at least one of polyamide, polyacrylonitrile, acrylate polymer, polyacrylic acid, polyacrylate, polyvinylpyrrolidone, polyvinyl ether, polyvinylidene fluoride, or vinylidene fluoride-hexafluoropropylene copolymer.

According to some embodiments of this application, the electrochemical device of this application includes, but is not limited to, all types of primary batteries or secondary batteries. In some embodiments, the electrochemical device is a lithium secondary battery. In some embodiments, the lithium secondary battery includes, but is not limited to, a lithium metal secondary battery, a lithium-ion secondary battery, a lithium polymer secondary battery, or a lithium-ion polymer secondary battery.

### 3. Electronic Device

The electronic device of this application may be any device using the electrochemical device according to the second aspect of this application.

In some embodiments, the electronic device includes, but is not limited to, a laptop, pen-input computer, mobile computer, e-book reader, portable phone, portable fax machine, portable copier, portable printer, headset stereo, video recorder, LCD television, portable vacuum cleaner, portable CD player, mini disc, transceiver, electronic notebook, calculator, memory card, portable recorder, radio, backup power supply, motor, automobile, motorcycle, assisted bicycle, bicycle, lighting fixture, toy, gaming console, clock, power tool, flashlight, camera, large household battery, or lithium-ion capacitor.

### EXAMPLES AND COMPARATIVE EXAMPLES

### Example 1

### Preparation of Positive Electrode Material

(1) A mixed solution containing NiSO₄ and MnSO₄ was prepared according to an element molar ratio of Ni:Mn=50:50. The mixed solution was reacted with a precipitant (NaOH solution) and a complexing agent (ammonia water), where controlling a reaction time to be 60 hours, ammonia water concentration to be 1 mol/L, and pH to be 12.2, obtaining a nickel-manganese precursor T(OH)₂ (T represents Ni/Mn) with an average particle size Dᵥ50 of 11 μm.

(2) The nickel-manganese precursor and sodium carbonate were ground and mixed uniformly at a molar ratio of (Ni+Mn):Na=1:1.05, calcined at 800° C. in an air atmosphere for 20 hours, then crushed, sieved, and demagnetized to obtain a first product.

(3) The first product was mixed with a lithium source (a mixture of lithium hydroxide and lithium nitrate at a molar ratio of 1:1), with a mass ratio of lithium source to first product of 10:1. The mixture was heated to 400° C. at a rate of 10° C./min, held for 14 hours, and then quenched to room temperature at a cooling rate of 50° C./min in a mixed gas of Ar and air (volume ratio of 1:1) to obtain a second product.

(4) The second product was washed and soaked in deionized water, dried, and then crushed and sieved to obtain the positive electrode material.

### Examples 2 to 10

The preparation differed from Example 1 in that the holding time in step (3) was adjusted to 13 hours, 12 hours, 11 hours, 10 hours, 8 hours, 6 hours, 5.5 hours, 5 hours, 4 hours, and 3 hours, respectively, to regulate the Na content in the positive electrode material.

### Preparation of Coin Cell

The positive electrode material, binder polyvinylidene fluoride (PVDF), and conductive agent conductive carbon black (Super P) were mixed at a weight ratio of 90:5:5, added to N-methylpyrrolidone (NMP), and mixed uniformly to prepare a positive electrode slurry with a solid content of 0.7. The mixed positive electrode slurry was evenly applied to one side of an aluminum foil with a coating thickness of 40 μm. After drying, a required electrode was obtained through rolling, where a coating surface density of the electrode was 14 mg/cm². The electrode was dried to obtain a positive electrode plate which was punched into a 14-mm disc to obtain a single-sided positive electrode plate. The separator was punched into an 18-mm disc. A negative electrode was a lithium metal sheet with an 18-mm diameter. In a solvent mixed with propylene carbonate (PC), ethylene carbonate (EC), and diethyl carbonate (DEC) (weight ratio of PC:EC:DEC=1:1:1), LiPF₆ was added and mixed uniformly to obtain an electrolyte, with a mass concentration of LiPF₆ of 12.5% based on a total weight of the electrolyte. The positive electrode plate, separator, negative electrode plate (lithium sheet), electrolyte, battery shell, and other components were transferred to a glovebox (water content was less than 11 ppm). The battery was assembled in the following order from bottom to top and injected with electrolyte: negative electrode shell>spring spacer+appropriate amount of electrolyte>metal lithium sheet+appropriate amount of electrolyte>one layer of separator+appropriate amount of electrolyte>positive electrode plate+appropriate amount of electrolyte>spring spacer+appropriate amount of electrolyte>spring>positive electrode shell. The battery was encapsulated using an encapsulation machine to obtain a coin cell.

### Preparation of Lithium-Ion Pouch Cell

Preparation of positive electrode: The positive electrode material, binder polyvinylidene fluoride (PVDF), and conductive agent conductive carbon black (Super P) were mixed at a weight ratio of 96:2:2, added to N-methylpyrrolidone (NMP), and mixed uniformly to prepare a positive electrode slurry with a solid content of 0.7. The mixed positive electrode slurry was evenly applied to one side surface of aluminum foil and dried, and the same steps were repeated on the other side surface of the aluminum foil to obtain a double-side coated positive electrode plate. After cold pressing, cutting, and welding tabs, the positive electrode was obtained.

Preparation of negative electrode: Artificial graphite, styrene-butadiene rubber, and sodium carboxymethyl cellulose (CMC) were mixed with deionized water at a mass ratio of 96:2:2 and stirred uniformly to obtain a negative electrode slurry. The negative electrode slurry was evenly applied to one side surface of copper foil and dried, and the same steps were repeated on the other side surface of the copper foil to obtain a double-side coated negative electrode plate. After cold pressing, cutting, and welding tabs, the negative electrode was obtained.

Preparation of electrolyte: In a dry argon atmosphere, LiPF₆ was added to a solvent mixed with propylene carbonate (PC), ethylene carbonate (EC), and diethyl carbonate (DEC) (weight ratio of PC:EC:DEC=1:1:1) and mixed uniformly to obtain an electrolyte, with a mass concentration of LiPF₆ of 12.5% based on a total weight of the electrolyte.

Preparation of separator: A polyethylene (PE) porous polymer film was used as the separator.

Assembly of lithium-ion pouch cell: The positive electrode, separator, and negative electrode were stacked in order, with the separator positioned between the positive and negative electrodes to provide isolation, and wound to obtain a bare cell. The bare cell was placed in an aluminum-plastic film outer packaging, injected with electrolyte, sealed, and subjected to formation, degassing, trimming, and other processes to obtain a lithium-ion pouch cell.

### Examples 11 to 24

The preparation differed from Example 7 in that step (2) was performed as follows.

(2) The nickel-manganese precursor, sodium carbonate, and element M source (potassium carbonate, magnesium carbonate, scandium oxide, or barium carbonate) were ground and mixed uniformly at a molar ratio of (Ni+Mn):Na=1:1.05 and M:(Ni+Mn+M) as shown in Table 1, calcined at 800° C. in an air atmosphere for 20 hours, then crushed, sieved, and demagnetized to obtain a first product.

### Comparative Example 1

Preparation of positive electrode material: (1) A mixed solution containing NiSO₄ and MnSO₄ was prepared according to an element molar ratio of Ni:Mn=50:50, reacted with a precipitant (NaOH solution) and a complexing agent (ammonia water). Controlling the reaction time to be 60 hours, ammonia water concentration to be 1 mol/L, and pH to be 12.2, obtaining a nickel-manganese precursor T(OH)₂ with an average particle size Dᵥ50 of 11 μm. (2) The nickel-manganese precursor and lithium carbonate were ground and mixed uniformly at a molar ratio of Li:(Ni+Mn)=1.02, calcined at 800° C. in an air atmosphere for 20 hours, cooled to room temperature at a rate of 10° C./min, and then crushed and sieved to obtain the positive electrode material.

### Comparative Example 2

Preparation of positive electrode material: (1) A mixed solution containing NiSO₄, CoSO₄, and MnSO₄ was prepared according to an element molar ratio of Ni:Co:Mn=80:10:10, reacted with a precipitant (NaOH solution) and a complexing agent (ammonia water). Controlling the reaction time to be 48 hours, ammonia water concentration to be 1 mol/L, and pH to be 12.8, obtaining a ternary precursor Ni_{0.8}Co_{0.1}Mn_{0.1}(OH)₂. (2) The ternary precursor and lithium hydroxide were ground and mixed uniformly at a molar ratio of Li:(Ni+Co+Mn)=1.02, calcined at 750° C. in an oxygen atmosphere for 20 hours, cooled to room temperature at a rate of 10° C./min, and then crushed and sieved to obtain the positive electrode material.

### Test Methods

### 1. Test of Cell Volume Change Rate for Charged to Specified Voltage

For the synthesized initial positive electrode materials in the examples and comparative examples, test was performed using an X-ray powder diffractometer (XRD, model: Bruker D8 ADVANCE; target: Cu Kα; voltage/current: 40 kV/40 mA; and scanning angle range: 10° to 70°). The XRD results were fitted using the Rietveld method to obtain cell parameters a, c, and cell volume V.

The coin cell was charged to a specified voltage (such as 4.0V or 4.4V) at a constant current of 0.1C within a range of 2.8V to 4.4V, disassembled to obtain the positive electrode plate, soaked and washed with dimethyl carbonate (DMC), dried, and subjected to the above XRD test. The XRD results were fitted using the Rietveld method to obtain cell volume V′. The corresponding specific charge capacity and cell volume V′ were recorded to obtain the relationship between cell volume and specific charge capacity:

$$cell volume change rate Δ V = ( {V}^{′} - V ) / \times 100 \%$$

### 2. Test of Thickness Swelling Rate for Float Charge at 4.45V

The lithium-ion pouch cell was charged to 4.45V at 45° C. with a constant current of 1C, and then charged at a constant voltage of 4.45V until the current reached 0.05C, with a battery thickness measured with a micrometer and recorded as H0. After standing at 45° C. for 1 hour, the battery was charged at a constant current of 0.4C to 4.45V, and then charged at a constant voltage of 4.45V for 1000 hours, with a battery thickness measured with a micrometer and recorded as H1. The thickness swelling rate for 4.45V float charge was calculated as: (H1−H0)/H0×100%.

### 3. Test of High-Temperature Storage Capacity Recovery Rate

The lithium-ion pouch cell was charged to 4.35V at 25° C. with a constant current of 0.7C, and then charged at a constant voltage of 4.35V until the current reached 0.02C to reach a fully charged state, followed by discharging with a constant current of 0.2C to 3.0V. This process was repeated twice, and a discharge capacity of the second cycle was recorded as C1. The lithium-ion pouch cell was fully charged according to the above steps, stored in a 60° C. constant temperature chamber for 60 days, and then taken out. After stabilizing at 25° C., the battery was cycled twice according to the above charge-discharge steps, and a discharge capacity of the second cycle was recorded as C2. High-temperature storage capacity recovery rate was calculated as: C2/C1×100%.

### 4. Test of Temperature Rise for 6C Discharge

The lithium-ion pouch cell was charged to 4.35V at 25° C. with a constant current of 1C, and then charged at a constant voltage of 4.35V until the current reached 0.05C. The battery was then discharged to 2.8V at a constant current of 6C. During this process, the battery was wrapped tightly with insulating cotton, and the battery temperature change was measured with a thermocouple. The 6C discharge temperature rise (° C.) was calculated as: temperature after discharge −25° C.

### 5. DCR Test

The lithium-ion pouch cell was charged to 4.35V at room temperature with a constant current of 1C, and then charged at a constant voltage of 4.35V until the current reached 0.05C to reach a fully charged state. The battery was then discharged at 0.2C to 50% SOC, with the voltage recorded as V0. The battery was then discharged with a current of 0.1C for 10 seconds, with a voltage recorded as V1. The current and voltage changes were recorded, and DCR was calculated as: (V0−V1)/I.

### 6. Simultaneous TG-MS/DSC Test

The coin cell was fully charged to 4.4V at a charge rate of 0.1C and disassembled. The disassembled positive electrode plate was soaked in dimethyl carbonate (DMC) to remove residual electrolyte, air-dried naturally, and transferred to a simultaneous TG-MS/DSC device. The temperature was raised to 700° C. at a rate of 3° C./min, and an oxygen signal generated during the process was collected.

### Test Results

The test results for the coin cells and lithium-ion pouch cells obtained in the examples and comparative examples are shown in Table 1. It can be learned from comparing Examples 1 to 24 with Comparative example 1 that the positive electrode materials in examples of this application, due to element Na doping in the lithium layers and abundant oxygen vacancies within and on the surface of the material, exhibit significantly increased cell volume change rates ΔV1 at 4.4V, enabling higher specific charge capacities of the positive electrode materials at the 4.4V charge state, thereby significantly improving the energy densities of lithium-ion batteries. Additionally, it can be learned from comparing Examples 1 to 24 with Comparative example 2 that the positive electrode materials in examples of this application, while having relatively high specific charge capacities, exhibit higher oxygen release onset temperatures, indicating that the oxygen vacancies formed within and on the surfaces of the positive electrode materials reduce the activity of oxygen in the materials, and element Na doping in the lithium layers suppressed structural collapse of the materials under high lithium deintercalation, thereby inhibiting oxygen release from the positive electrode materials and improving the structural stability of the positive electrode materials under high temperature and high voltage, resulting in lower float charge thickness swelling rates and higher high-temperature storage capacity recovery rates for lithium-ion batteries. Furthermore, the positive electrode materials in these examples of this application exhibit larger cell parameters c, and corresponding lithium-ion batteries exhibit significantly reduced 6C discharge temperature rise and DCR, indicating that the positive electrode materials in these examples of this application, due to element Na doping in the lithium layers and abundant oxygen vacancies within and on the surfaces of the material, increase the lithium-oxygen interlayer spacing, promote full lithium-ion intercalation/deintercalation, and enhance kinetic performance of the material.

TABLE 1

| | | | | Specific | Cell | Cell | | |
|---|---|---|---|---|---|---|---|---|
| | | | | charge | volume | volume | | |
| | Na:(T + M) | | M:(T + M) | capacity at | change | change | | |
| | molar | Element | molar | 4.4 V | rate ΔV1 | rate ΔV2 | | |
| | percentage | M | percentage | (mAh/g) | at 4.4 V | at 4.0 V | a (Å) | c (Å) |
| Comparative | / | / | / | 190 | 3.2% | 2% | 2.88 | 14.29 |
| example 1 | | | | | | | | |
| Comparative | / | / | / | 230 | 6.2% | 2% | 2.87 | 14.22 |
| example 2 | | | | | | | | |
| Example 1 | 0.50% | / | / | 220 | 7.0% | 2.3% | 2.89 | 14.3 |
| Example 2 | 0.80% | / | / | 223 | 7.5% | 2.4% | 2.89 | 14.32 |
| Example 3 | 1.00% | / | / | 225 | 7.9% | 2.5% | 2.89 | 14.34 |
| Example 4 | 2.00% | / | / | 225 | 8.2% | 2.6% | 2.9 | 14.36 |
| Example 5 | 3.00% | / | / | 226 | 8.5% | 2.7% | 2.9 | 14.38 |
| Example 6 | 5.00% | / | / | 228 | 8.8% | 2.8% | 2.9 | 14.39 |
| Example 7 | 8.00% | / | / | 230 | 8.6% | 2.8% | 2.9 | 14.4 |
| Example 8 | 10.00% | / | / | 229 | 8.3% | 2.7% | 2.9 | 14.4 |
| Example 9 | 15.00% | / | / | 228 | 8.2% | 2.6% | 2.9 | 14.4 |
| Example 10 | 20.00% | / | / | 227 | 8.1% | 2.6% | 2.9 | 14.39 |
| Example 11 | 8.00% | K | 0.30% | 229 | 8.9% | 2.9% | 2.92 | 14.44 |
| Example 12 | 8.00% | K | 0.60% | 230 | 9% | 2.9% | 2.94 | 14.52 |
| Example 13 | 8.00% | K | 1.10% | 232 | 9% | 2.9% | 2.95 | 14.53 |
| Example 14 | 8.00% | K | 1.60% | 233 | 10% | 3.2% | 2.95 | 14.55 |
| Example 15 | 8.00% | K | 2.10% | 235 | 9% | 2.9% | 2.96 | 14.57 |
| Example 16 | 8.00% | K | 5.10% | 235 | 9% | 2.9% | 2.95 | 14.55 |
| Example 17 | 8.00% | Mg | 2.10% | 236 | 9% | 2.9% | 2.96 | 14.57 |
| Example 18 | 8.00% | Mg | 5.10% | 237 | 8% | 2.6% | 2.95 | 14.55 |
| Example 19 | 8.00% | Sc | 2.10% | 235 | 8% | 2.6% | 2.99 | 14.79 |
| Example 20 | 8.00% | Sc | 5.10% | 235 | 8% | 2.6% | 2.96 | 14.68 |
| Example 21 | 8.00% | Ba | 0.60% | 225 | 10% | 3.2% | 2.95 | 14.59 |
| Example 22 | 8.00% | Ba | 1.10% | 226 | 10% | 3.2% | 2.97 | 14.69 |
| Example 23 | 8.00% | Ba | 1.60% | 233 | 11% | 3.5% | 2.99 | 14.79 |
| Example 24 | 8.00% | Ba | 3.10% | 235 | 10% | 3.2% | 2.96 | 14.68 |

| | | Presence | | | | | |
|---|---|---|---|---|---|---|---|
| | | of first | | | | | |
| | | oxidation | Oxygen | Thickness | High- | | |
| | | peak and | release | swelling | temperature | Temperature | |
| | | first | onset | rate for | storage | rise for 6 C | |
| | | reduction | temperature | 4.45 V float | capacity | discharge | DCR |
| | V (Å³) | peak | (° C.) | charge | recovery rate | (° C.) | (mohm) |
| Comparative | 102.96 | No | 250 | 40% | 70% | 39.5 | 80 |
| example 1 | | | | | | | |
| Comparative | 101.69 | No | 215 | 40% | 71% | 37.4 | 51 |
| example 2 | | | | | | | |
| Example 1 | 103.43 | Yes | 220 | 24% | 80% | 36 | 47 |
| Example 2 | 103.72 | Yes | 245 | 19% | 81% | 35.5 | 45 |
| Example 3 | 104.01 | Yes | 250 | 16% | 84% | 35 | 44 |
| Example 4 | 104.3 | Yes | 255 | 14% | 86% | 34 | 42 |
| Example 5 | 104.59 | Yes | 260 | 12% | 88% | 33 | 39 |
| Example 6 | 104.73 | Yes | 270 | 10% | 90% | 32 | 38 |
| Example 7 | 104.76 | Yes | 282 | 8% | 92% | 31 | 35 |
| Example 8 | 104.65 | Yes | 285 | 10% | 90% | 32 | 36 |
| Example 9 | 104.63 | Yes | 280 | 12% | 88% | 33 | 37 |
| Example 10 | 104.55 | Yes | 275 | 15% | 85% | 34 | 38 |
| Example 11 | 106.64 | Yes | 305 | 6% | 96% | 26 | 30 |
| Example 12 | 108.69 | Yes | 310 | 5% | 97% | 24 | 28 |
| Example 13 | 109.21 | Yes | 325 | 4% | 98% | 22 | 26 |
| Example 14 | 109.66 | Yes | 330 | 2% | 99% | 20 | 24 |
| Example 15 | 110.18 | Yes | 315 | 4% | 98% | 21 | 25 |
| Example 16 | 109.81 | Yes | 312 | 7% | 95% | 22 | 26 |
| Example 17 | 110.18 | Yes | 315 | 4% | 98% | 21 | 25 |
| Example 18 | 109.66 | Yes | 330 | 5% | 96% | 23 | 27 |
| Example 19 | 114.51 | Yes | 348 | 2% | 98% | 18 | 22 |
| Example 20 | 111.39 | Yes | 330 | 4% | 96% | 19 | 23 |
| Example 21 | 109.96 | Yes | 325 | 3% | 97% | 20 | 24 |
| Example 22 | 112.22 | Yes | 345 | 2% | 98% | 19 | 23 |
| Example 23 | 114.51 | Yes | 348 | 2% | 98% | 18 | 22 |
| Example 24 | 111.39 | Yes | 330 | 3% | 96% | 19 | 23 |

### Examples 25 to 39

The preparation differed from Example 1 in that the electrolyte was prepared as follows: In a dry argon atmosphere, an additive was added to a solvent mixed with propylene carbonate (PC), ethylene carbonate (EC), and diethyl carbonate (DEC) (weight ratio of PC:EC:DEC=1:1:1) according to Table 2, followed by the addition of LiPF₆ and uniform mixing to obtain the electrolyte, where the contents of the additive and LiPF₆ were based on a total weight of the electrolyte, and a mass concentration of LiPF₆ was 12.5%.

TABLE 2

| | | | High-temperature |
|---|---|---|---|
| | | Additive mass | storage capacity |
| | Additive type | percentage | recovery rate |
| Example 1 | / | / | 80% |
| Example 25 | 1,3-propane sultone | 0.1% | 82% |
| Example 26 | 1,3-propane sultone | 0.2% | 83.5% |
| Example 27 | 1,3-propane sultone | 0.5% | 85% |
| Example 28 | 1,3-propane sultone | 1% | 84% |
| Example 29 | 1,3-propane sultone | 2% | 83% |
| Example 30 | Ethylene sulfate | 0.5% | 84% |
| Example 31 | 1,4-butane sultone | 0.5% | 83.5% |
| Example 32 | Succinonitrile | 0.5% | 84% |
| Example 33 | Succinonitrile | 1% | 84.6% |
| Example 34 | Succinonitrile | 3% | 85% |
| Example 35 | Succinonitrile | 5% | 84.8% |
| Example 36 | Adiponitrile | 3% | 86% |
| Example 37 | 1,2-bis(2- | 3% | 85.5% |
| | cyanoethoxy)ethane | | |
| Example 38 | 1,3,6- | 3% | 88% |
| | hexanetricarbonitrile | | |
| Example 39 | 1,3-propane | 0.5% + 3% | 91% |
| | sultone + 1,3,6- | | |
| | hexanetricarbonitrile | | |

It can be learned from comparing Examples 25 to 39 with Example 1 in Table 2 that the high-temperature storage capacity recovery rates of lithium-ion batteries are further improved by adding sulfur-oxygen double bond containing compounds and/or multi-cyano containing compounds to the electrolyte. The possible reason is that sulfur-oxygen double bond containing compounds form an oxidation-resistant protective film on the surfaces of the positive electrode materials, and the abundant element S may stabilize high-valence transition metals in the charged state, thereby better suppressing oxygen release from the surfaces of the positive electrode materials and oxidative decomposition of the electrolyte; and the multi-cyano containing compound can complex with transition metals on the surfaces of the positive electrode active materials, stabilizing transition metals such as nickel, cobalt, and manganese on the surfaces of the positive electrode materials, suppressing oxygen release from the surfaces of the positive electrode materials, thereby improving the structural stability of the positive electrode material under high-temperature storage.

Although some exemplary embodiments of this application have been described and illustrated, this application is not limited to the disclosed embodiments. On the contrary, those skilled in the art should recognize that, without departing from the spirit and principles of this application, some modifications and changes can be made to the described embodiments, and these modifications and changes also fall within the protection scope of this application.

What is claimed is:

1. A positive electrode material, wherein a specific charge capacity of the positive electrode material is greater than or equal to 220 mAh/g, and a cell volume change rate ΔV1 of the positive electrode material is 7% to 11%; the specific charge capacity of the positive electrode material and the cell volume change rate ΔV1 of the positive electrode material being measured by assembling an electrode comprising the positive electrode material with a lithium sheet into a coin cell, and charging the coin cell to 4.4V at a constant current of 0.1C within a range of 2.8V to 4.4V.

2. The positive electrode material according to claim 1, wherein a cell volume change rate ΔV2 of the positive electrode material is less than or equal to 3.5%; the cell volume change rate ΔV2 of the positive electrode material being measured by assembling an electrode comprising the positive electrode material with a lithium sheet into a coin cell, and charging the coin cell to 4.0V at a constant current of 0.1C within a range of 2.8V to 4.4V.

3. The positive electrode material according to claim 1, wherein a cell parameter a, cell parameter c, and a cell volume V of the positive electrode material satisfy at least one of the following conditions:
$$2.8 Å \leq a \leq 3. Å ; \qquad ( 1 )$$
$$14.3 Å \leq c \leq 14.8 Å ; \qquad ( 2 )$$
$$or$$
$$103 {Å}^{3} \leq V \underline{<} 115 {Å}^{3} . \qquad ( 3 )$$

4. The positive electrode material according to claim 1, wherein when the coin cell is charged to 4.4V at the constant current of 0.1C within the range of 2.8V to 4.4V, an oxygen release onset temperature of the positive electrode material is greater than or equal to 220° C.

5. The positive electrode material according to claim 1, wherein when an electrode comprising the positive electrode material is assembled with a lithium sheet into a coin cell, and the coin cell is charged and discharged at a current of 0.1C within a range of 2.8V to 4.4V, an obtained differential capacity to voltage dQ/dV curve exhibits a first oxidation peak and a first reduction peak within a range of 4.2V to 4.4V.

6. The positive electrode material according to claim 1, wherein the positive electrode material comprises a lithium transition metal composite oxide; the lithium transition metal composite oxide comprises an element T, or both the element T and an element M; wherein the element T comprises at least one selected from the group consisting of Ni, Co, and Mn; and the element M comprises at least one selected from the group consisting of K, Ca, Sr, Y, Zr, Nb, Mo, In, Sn, Sb, Ba, La, Ce, Hf, Ta, W, Pb, Al, Mg, B, Si, P, S, Ti, V, Cr, Fe, Cu, Zn, Ga, and Ge; and the lithium transition metal composite oxide satisfies at least one of the following conditions:
(1) based on a total molar amount of element T, a molar percentage of Ni is 30% to 70%;
(2) based on a total molar amount of element T, a molar percentage of Mn is 0% to 70%;
(3) based on a total molar amount of element T, a molar percentage of Co is 0% to 50%;
(4) based on a total molar amount of the element T and the element M in the lithium transition metal composite oxide, a molar percentage of the element T in the lithium transition metal composite oxide is 90% to 100%, and a molar percentage of the element M in the lithium transition metal composite oxide is 0% to 10%;
(5) the lithium transition metal composite oxide further comprises an element R, wherein the element R comprises at least one selected from the group consisting of F, Cl, Br, I, and N; and based on a total molar amount of the element T and the element M in the lithium transition metal composite oxide, a molar percentage of element R is 0.1% to 10%;
(6) in the lithium transition metal composite oxide, a ratio of a molar amount of element Li to a total molar amount of the element T and the element M is 0.5 to 1.1;
(7) the lithium transition metal composite oxide further comprises element Na, and based on the total molar amount of the element T and the element M in the lithium transition metal composite oxide, a molar percentage of the element Na is 0.1% to 20%;
(8) the lithium transition metal composite oxide has a layered crystal structure; or
(9) the lithium transition metal composite oxide comprises Liₓ₁Naₓ₂Ni_{y1}Mn_{y2}Co_{y3}M_{z1}O_{2±m}Rₘ, wherein 0.5≤x1≤1.1, 0.001≤x2≤0.2, 0.3≤y1≤0.7, 0≤y2≤0.7, 0≤y3≤0.5, 0≤z1≤0.1, and 0≤m≤0.1, and element R comprises at least one selected from the group consisting of F, Cl, Br, I, and N.

7. An electrochemical device, comprising a positive electrode plate, and the positive electrode plate comprises a positive electrode material, wherein a specific charge capacity of the positive electrode material is greater than or equal to 220 mAh/g, and a cell volume change rate ΔV1 of the positive electrode material is 7% to 11%; the specific charge capacity of the positive electrode material and the cell volume change rate ΔV1 of the positive electrode material being measured by assembling an electrode comprising the positive electrode material with a lithium sheet into a coin cell, and charging the coin cell to 4.4V at a constant current of 0.1C within a range of 2.8V to 4.4V.

8. The electrochemical device according to claim 7, wherein a cell volume change rate ΔV2 of the positive electrode material is less than or equal to 3.5%; the cell volume change rate ΔV2 of the positive electrode material being measured by assembling an electrode comprising the positive electrode material with a lithium sheet into a coin cell, and charging the coin cell to 4.0V at a constant current of 0.1C within a range of 2.8V to 4.4V.

9. The electrochemical device according to claim 7, wherein a cell parameter a, cell parameter c, and a cell volume V of the positive electrode material satisfy at least one of the following conditions:
$$2.8 Å \leq a \leq 3. Å ; \qquad ( 1 )$$
$$14.3 Å \leq c \leq 14.8 Å ; \qquad ( 2 )$$
$$or$$
$$103 {Å}^{3} \leq V \underline{<} 115 {Å}^{3} . \qquad ( 3 )$$

10. The electrochemical device according to claim 7, wherein when the coin cell is charged to 4.4V at the constant current of 0.1C within the range of 2.8V to 4.4V, an oxygen release onset temperature of the positive electrode material is greater than or equal to 220° C.

11. The electrochemical device according to claim 7, wherein when an electrode comprising the positive electrode material is assembled with a lithium sheet into a coin cell, and the coin cell is charged and discharged at a current of 0.1C within a range of 2.8V to 4.4V, an obtained differential capacity to voltage dQ/dV curve exhibits a first oxidation peak and a first reduction peak within a range of 4.2V to 4.4V.

12. The electrochemical device according to claim 7, wherein the positive electrode material comprises a lithium transition metal composite oxide; the lithium transition metal composite oxide comprises an element T, or both the element T and an element M; wherein the element T comprises at least one selected from the group consisting of Ni, Co, and Mn; and the element M comprises at least one selected from the group consisting of K, Ca, Sr, Y, Zr, Nb, Mo, In, Sn, Sb, Ba, La, Ce, Hf, Ta, W, Pb, Al, Mg, B, Si, P, S, Ti, V, Cr, Fe, Cu, Zn, Ga, and Ge; and the lithium transition metal composite oxide satisfies at least one of the following conditions:
(1) based on a total molar amount of element T, a molar percentage of Ni is 30% to 70%;
(2) based on a total molar amount of element T, a molar percentage of Mn is 0% to 70%;
(3) based on a total molar amount of element T, a molar percentage of Co is 0% to 50%;
(4) based on a total molar amount of the element T and the element M in the lithium transition metal composite oxide, a molar percentage of the element T in the lithium transition metal composite oxide is 90% to 100%, and a molar percentage of the element M in the lithium transition metal composite oxide is 0% to 10%;
(5) the lithium transition metal composite oxide further comprises an element R, wherein the element R comprises at least one selected from the group consisting of F, Cl, Br, I, and N; and based on a total molar amount of the element T and the element M in the lithium transition metal composite oxide, a molar percentage of element R is 0.1% to 10%;
(6) in the lithium transition metal composite oxide, a ratio of a molar amount of element Li to a total molar amount of the element T and the element M is 0.5 to 1.1;
(7) the lithium transition metal composite oxide further comprises element Na, and based on the total molar amount of the element T and the element M in the lithium transition metal composite oxide, a molar percentage of the element Na is 0.1% to 20%;
(8) the lithium transition metal composite oxide has a layered crystal structure; or
(9) the lithium transition metal composite oxide comprises Liₓ₁Naₓ₂Ni_{y1}Mn_{y2}Co_{y3}M_{z1}O_{2±m}Rₘ, wherein 0.5≤x1≤1.1, 0.001≤x2≤0.2, 0.3≤y1≤0.7, 0≤y2≤0.7, 0≤y3≤0.5, 0≤z1≤0.1, and 0≤m≤0.1, and element R comprises at least one selected from the group consisting of F, Cl, Br, I, and N.

13. The electrochemical device according to claim 7, wherein the electrochemical device further comprises an electrolyte, wherein the electrolyte comprises an additive, the additive comprises at least one of a sulfur-oxygen double bond containing compound or a multi-cyano containing compound, and the electrolyte satisfies at least one of the following conditions:
(1) the sulfur-oxygen double bond containing compound comprises at least one of 1,3-propane sultone, ethylene sulfate, 2,4-butane sultone, 1,4-butane sultone, methylene methanedisulfonate, 1,3-propane disulfonic anhydride, 4-methyl vinyl sulfate, or pentaerythritol bicyclic sulfate;
(2) based on a mass of the electrolyte, a mass percentage of the sulfur-oxygen double bond containing compound is 0.1% to 5%;
(3) the multi-cyano containing compound comprises at least one of succinonitrile, glutaronitrile, adiponitrile, pimelonitrile, suberonitrile, azelanitrile, sebaconitrile, methyl glutaronitrile, 1,2-bis(2-cyanoethoxy)ethane, 1,3,5-pentanetricarbonitrile, 1,3,6-hexanetricarbonitrile, or 1,2,3-tris(2-cyanoethoxy)propane; or
(4) based on a mass of the electrolyte, a mass percentage of the multi-cyano containing compound is 0.5% to 10%.

14. An electronic device, comprising an electrochemical device, the electrochemical device comprises a positive electrode plate, and the positive electrode plate comprises a positive electrode material, wherein a specific charge capacity of the positive electrode material is greater than or equal to 220 mAh/g, and a cell volume change rate ΔV1 of the positive electrode material is 7% to 11%; the specific charge capacity of the positive electrode material and the cell volume change rate ΔV1 of the positive electrode material being measured by assembling an electrode comprising the positive electrode material with a lithium sheet into a coin cell, and charging the coin cell to 4.4V at a constant current of 0.1C within a range of 2.8V to 4.4V.

15. The electronic device according to claim 14, wherein a cell volume change rate ΔV2 of the positive electrode material is less than or equal to 3.5%; the cell volume change rate ΔV2 of the positive electrode material being measured by assembling an electrode comprising the positive electrode material with a lithium sheet into a coin cell, and charging the coin cell to 4.0V at a constant current of 0.1C within a range of 2.8V to 4.4V.

16. The electronic device according to claim 14, wherein a cell parameter a, cell parameter c, and a cell volume V of the positive electrode material satisfy at least one of the following conditions:
$$2.8 Å \leq a \leq 3. Å ; \qquad ( 1 )$$
$$14.3 Å \leq c \leq 14.8 Å ; \qquad ( 2 )$$
$$or$$
$$103 {Å}^{3} \leq V \underline{<} 115 {Å}^{3} . \qquad ( 3 )$$

17. The electronic device according to claim 14, wherein when the coin cell is charged to 4.4V at the constant current of 0.1C within the range of 2.8V to 4.4V, an oxygen release onset temperature of the positive electrode material is greater than or equal to 220° C.

18. The electronic device according to claim 14, wherein when an electrode comprising the positive electrode material is assembled with a lithium sheet into a coin cell, and the coin cell is charged and discharged at a current of 0.1C within a range of 2.8V to 4.4V, an obtained differential capacity to voltage dQ/dV curve exhibits a first oxidation peak and a first reduction peak within a range of 4.2V to 4.4V.

19. The electronic device according to claim 14, wherein the positive electrode material comprises a lithium transition metal composite oxide; the lithium transition metal composite oxide comprises an element T, or both the element T and an element M; wherein the element T comprises at least one selected from the group consisting of Ni, Co, and Mn; and the element M comprises at least one selected from the group consisting of K, Ca, Sr, Y, Zr, Nb, Mo, In, Sn, Sb, Ba, La, Ce, Hf, Ta, W, Pb, Al, Mg, B, Si, P, S, Ti, V, Cr, Fe, Cu, Zn, Ga, and Ge; and the lithium transition metal composite oxide satisfies at least one of the following conditions:
(1) based on a total molar amount of element T, a molar percentage of Ni is 30% to 70%;
(2) based on a total molar amount of element T, a molar percentage of Mn is 0% to 70%;
(3) based on a total molar amount of element T, a molar percentage of Co is 0% to 50%;
(4) based on a total molar amount of the element T and the element M in the lithium transition metal composite oxide, a molar percentage of the element T in the lithium transition metal composite oxide is 90% to 100%, and a molar percentage of the element M in the lithium transition metal composite oxide is 0% to 10%;
(5) the lithium transition metal composite oxide further comprises an element R, wherein the element R comprises at least one selected from the group consisting of F, Cl, Br, I, and N; and based on a total molar amount of the element T and the element M in the lithium transition metal composite oxide, a molar percentage of element R is 0.1% to 10%;
(6) in the lithium transition metal composite oxide, a ratio of a molar amount of element Li to a total molar amount of the element T and the element M is 0.5 to 1.1;
(7) the lithium transition metal composite oxide further comprises element Na, and based on the total molar amount of the element T and the element M in the lithium transition metal composite oxide, a molar percentage of the element Na is 0.1% to 20%;
(8) the lithium transition metal composite oxide has a layered crystal structure; or
(9) the lithium transition metal composite oxide comprises Liₓ₁Naₓ₂Ni_{y1}Mn_{y2}Co_{y3}M_{z1}O_{2±m}Rₘ, wherein 0.5≤x1≤1.1, 0.001≤x2≤0.2, 0.3≤y1≤0.7, 0≤y2≤0.7, 0≤y3≤0.5, 0≤z1≤0.1, and 0≤m≤0.1, and element R comprises at least one selected from the group consisting of F, Cl, Br, I, and N.

20. The electronic device according to claim 14, wherein the electrochemical device further comprises an electrolyte, wherein the electrolyte comprises an additive, the additive comprises at least one of a sulfur-oxygen double bond containing compound or a multi-cyano containing compound, and the electrolyte satisfies at least one of the following conditions:
(1) the sulfur-oxygen double bond containing compound comprises at least one of 1,3-propane sultone, ethylene sulfate, 2,4-butane sultone, 1,4-butane sultone, methylene methanedisulfonate, 1,3-propane disulfonic anhydride, 4-methyl vinyl sulfate, or pentaerythritol bicyclic sulfate;
(2) based on a mass of the electrolyte, a mass percentage of the sulfur-oxygen double bond containing compound is 0.1% to 5%;
(3) the multi-cyano containing compound comprises at least one of succinonitrile, glutaronitrile, adiponitrile, pimelonitrile, suberonitrile, azelanitrile, sebaconitrile, methyl glutaronitrile, 1,2-bis(2-cyanoethoxy)ethane, 1,3,5-pentanetricarbonitrile, 1,3,6-hexanetricarbonitrile, or 1,2,3-tris(2-cyanoethoxy)propane; or
(4) based on a mass of the electrolyte, a mass percentage of the multi-cyano containing compound is 0.5% to 10%.
